(19) United States
(12) Patent Application Publication
(10) Pub. No.: US 2026/0274531 A1
(43) Pub. Date: Sep. 17, 2026

(54) GROUP LOCKOUT BOX COMPRISING MECHANICAL SEAL

(71) Applicant: Tradebase Holdings LC, Sheridan, WY (US)

(72) Inventor: Sean Levi Hennessy, Scottsdale, AZ (US)

(21) Appl. No.: 19/080,746

(22) Filed: Mar. 14, 2025

(51) Int. Cl. B65D 55/14; B65D 25/14; B65D 25/28; B65D 25/54; B65D 43/16

(52) U.S. Cl. CPC B65D 55/14; B65D 25/14; B65D 25/2826; B65D 25/54; B65D 43/163

(57) ABSTRACT

A group lockout box for securely storing keys is disclosed. The group lockout box includes a housing to receive and store the keys. The group lockout box includes a cover disposed on the body to allow or prevent access into an interior of the body, a handle, and a fastener that receives a padlock to securely close the cover and to prevent access into the interior of the body. A slot disposed on the cover is configured to allow passage of a key into the interior of the body without opening the cover. A mechanical seal is disposed within the slot to allow passage of the key through the slot into the interior without opening the cover, and then seal the slot upon passage of the key through the slot to prevent access into the interior of the body.

### CROSS-REFERENCE TO RELATED APPLICATIONS

N/A

### BACKGROUND OF THE INVENTION

### 1. Field of the Invention

The present invention relates to group lockout boxes but more particularly to a group lockout box comprising a mechanical seal.

### 2. Description of Related Art

Generally, group lockout boxes are essential components in safety protocols across various industrial settings, including manufacturing plants, energy facilities, and maintenance environments. Such devices are designed to securely store keys required for the operation of locked-out equipment, ensuring that machinery cannot be reactivated without proper authorization. In environments where multiple personnel work on the same equipment, group lockout boxes provide a centralized and organized solution to prevent unauthorized access, thereby enhancing safety and operational control.

However, in certain scenarios, group lockout boxes may become vulnerable to tampering or unauthorized access attempts. For example, if a key inside the group lockout box were to be accessed or removed without permission, it could enable unauthorized reactivation of machinery that is under maintenance, risking injury to personnel and potential damage to equipment. Such an issue is particularly critical in high-risk environments, such as chemical plants or heavy manufacturing facilities, where the inadvertent startup of machinery could lead to severe safety hazards.

Generally, group lockout boxes are available to secure keys for equipment under lockout/tagout procedures. However, conventional designs may lack effective measures to prevent keys inserted into the group lockout boxes from falling back out through the key drop slot. Moreover, some group lockout boxes do not reliably prevent access into the boxes, leaving the stored keys susceptible to unauthorized access through external tools or devices. Such limitations in conventional group lockout boxes compromise the reliability of lockout/tagout protocols.

In response to the aforesaid needs and to address the aforementioned issues, there is a clear need for an improved group lockout box that offers enhanced security for stored keys. Such a group lockout box should ensure that keys remain securely stored within the group lockout box once the keys are inserted into the box, preventing the keys from accidentally falling out through the key drop slot, thereby preventing misplacement or loss of keys.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present disclosure to provide a group lockout box for securely storing keys, preventing the keys from accidentally falling out through the key drop slot, thereby preventing misplacement or loss of keys.

In order to do this, a group lockout box for securely storing keys is provided, the group lockout box comprising a housing defining an interior for receiving one or more keys, the housing comprising a body; a cover coupled to the body so as to be movable between an open position and a closed position in which access to the interior is prevented; a cover locking mechanism configured to secure the cover in the closed position; a slot disposed in the cover, the slot being dimensioned to allow passage of at least one key into the interior without opening the cover; and a mechanical seal disposed adjacent to the slot and configured to permit one-way insertion of the key into the interior and to prevent retrieval of the key through the slot after insertion.

In one embodiment, the mechanical seal comprises a spring-loaded cover including a cover plate sized larger than the slot; and a spring hinge connected to the cover plate, wherein the spring hinge biases the cover plate toward a closed position beneath the slot. In another embodiment, a mounting plate fixed to an underside of the cover is provided, wherein the spring hinge pivotally connects the cover plate to the mounting plate such that the cover plate automatically returns to cover the slot and prevents passage of the key back through the slot after insertion. In one embodiment, the mounting plate is attached to the underside of the cover by one or more fasteners. In yet another embodiment, the mechanical seal comprises a flexible diaphragm configured to allow the key to pass therethrough in a one-way manner. In one embodiment, the cover locking mechanism is implemented as a latch clamp pivotally connected to the cover and configured to receive the padlock so as to secure the cover in the closed position. In one embodiment, a handle disposed on the cover for carrying the group lockout box is provided. In another embodiment, at least one of the body or the cover includes a window or an opening that allows visual inspection of the interior without opening the cover. In yet another embodiment, a magnetic surface disposed along a bottom interior region of the body is provided, the magnetic surface being configured to retain the key in a substantially fixed position within the interior once inserted. In one embodiment, the slot has a shape selected from the group consisting of a rectangular slot, a keyhole slot, and an oval slot configured to limit insertion of unauthorized tools.

The foregoing has outlined rather broadly the more pertinent and important features of the present disclosure so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a front, right and top perspective view of a group lockout box for securely storing keys therein, in accordance with an embodiment of the present disclosure;

FIG. 2 shows a right-hand side sectional view taken through the middle of the group lockout box of FIG. 1 with some portions removed for illustrative purposes, in accordance with an embodiment of the present disclosure;

FIG. 3 shows a right-hand side sectional view taken through the middle of the group lockout box of FIG. 1 with some portions removed for illustrative purposes, but with the key being inserted in the slot, in accordance with an embodiment of the present disclosure; and

FIG. 4 shows a right-hand side sectional view taken through the middle of the group lockout box of FIG. 1 with some portions removed for illustrative purposes, in accordance with an alternate embodiment of the present disclosure.

### DETAILED DESCRIPTION OF THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

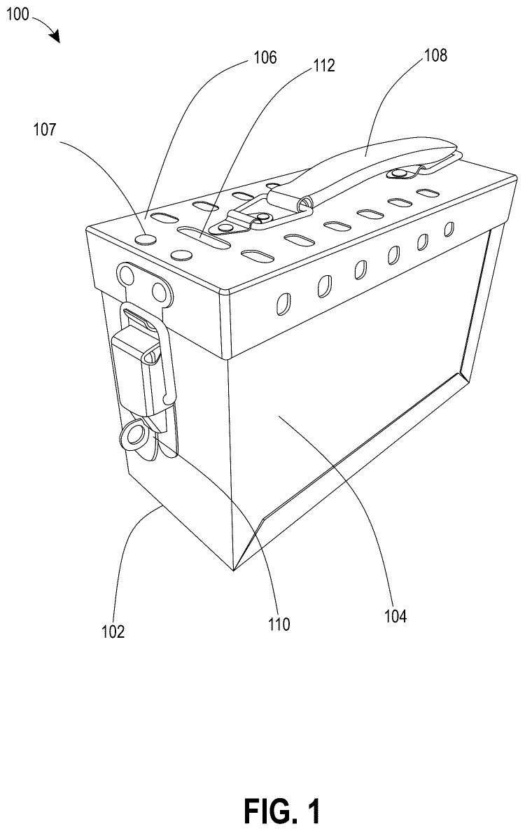

FIG. 1 shows a group lockout box 100 for securely storing keys therein, in accordance with an embodiment of the present disclosure. The group lockout box 100 comprises a housing 102 to receive and store the keys. The housing 102 serves as a durable enclosure that restricts unauthorized access to stored keys, withstanding environmental conditions and wear in industrial and controlled settings. In some embodiments, the housing 102 is fabricated from materials such as high-impact plastics, including polycarbonate or acrylonitrile butadiene styrene (ABS), to provide durability against external forces. Alternatively, alloys such as steel, stainless steel or aluminum alloy may be used, ensuring additional strength and longevity in rugged environments. Further, the housing 102 may be produced in various dimensions to accommodate different storage needs and workspace requirements, providing a flexible solution suitable for diverse industries.

In one embodiment, the housing 102 comprises a body 104, a cover 106 disposed on the body 104 to allow or prevent access into an interior of the body 104, a handle 108, and a cover locking mechanism 110. In one embodiment, the cover locking mechanism 110 is operatively connected to the cover 106 and the body 104. During use, the cover locking mechanism 110 is configured to securely close and lock the cover 106 with respect to the body 104 via a padlock in a padlock slot or other type of locking member. In one embodiment, the cover locking mechanism 110 is a latch clamp, however other types of locking mechanism may be used, including but not limited to bolt latches, rotary latches, hasp & staple lock, magnetic latches, compression latches, or other similar mechanisms.

The body 104 acts as the foundation of the housing 102 and is configured to securely hold the keys therein while preventing unauthorized access thereto. In some embodiments, the body 104 may be fabricated with additional structural reinforcements, such as molded ribs or thicker walls, to resist tampering efforts. The body 104 can be designed in shapes such as rectangular or trapezoidal, providing compatibility with a range of mounting setups and ensuring a secure, stable base for the cover 106. It should also be appreciated that the body 104 can have various other geometric configurations, including but not limited to cylindrical, oval, or other polygonal or curved shapes, depending on design preferences and functional requirements. In some embodiments, the body 104 may also be textured or coated with scratch-resistant finishes, ensuring durability and maintaining the structural integrity of the group lockout box 100 over prolonged usage.

The cover 106 is disposed on the body 104 to selectively allow or restrict access to the interior that securely stores the keys within the body 104. The cover 106 closes over the body 104, preventing entry to the stored keys and enhancing tamper resistance. In some embodiments, the cover 106 may be fabricated from impact-resistant materials similar to those of the body 104 and may be designed to align closely with the body 104, protecting the interior from environmental contaminants such as dust or moisture. Further, in some embodiments, the cover 106 can be manufactured with varying thicknesses to ensure versatility, enhancing security for specific applications where stronger barriers are required.

In one embodiment, the handle 108 is disposed on the cover 106 to enable easy portability of the group lockout box 100. In one embodiment, the handle 108 can be designed with ergonomic features, such as a soft-grip or rubberized surface, ensuring user comfort when the box is moved between locations. In some embodiments, the handle 108 can be fabricated in different configurations, including top-mounted or side-mounted orientations, providing flexibility in handling and usage based on user preference. In some embodiments, the handle 108 may be constructed from materials such as molded plastic for lightweight convenience or rubber-coated metal for added durability in industrial settings.

As previously discussed, the cover locking mechanism 110 securely closes the cover 106 with respect to the body 104, ensuring that unauthorized access to the interior is prevented, via a padlock (not illustrated), enhancing the security of the group lockout box 100 by preventing the cover 106 from being opened without proper authorization. As discussed, the cover locking mechanism 110 can be implemented as a reinforced hasp or latch, fabricated from materials such as stainless steel to withstand tampering and environmental stresses. The cover locking mechanism 110 may also be coated with anti-corrosive finishes to further ensure reliability, allowing for long-term usage in environments where moisture or chemicals may be present. Such a configuration offers compatibility with multiple padlock sizes, allowing versatile use across a variety of secure applications.

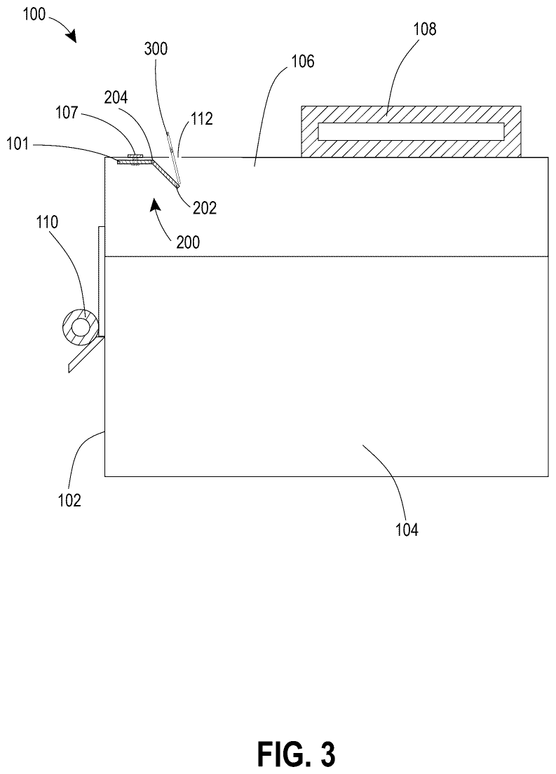

Advantageously, the group lockout box 100 comprises a slot 112 disposed on the cover 106 to allow passage of a key 300 (shown in FIG. 3) into the interior of the body 104 without opening the cover 106. The slot 112 is dimensioned to permit entry of standard key sizes while preventing unauthorized retrieval of keys from the interior. In some embodiments, the slot 112 may include beveled or recessed edges, preventing tools from being inserted for unauthorized access, thereby enhancing the security of the group lockout box 100. Additionally, in some embodiments, the slot 112 may include a reinforced border to withstand wear from repeated usage, ensuring consistent protection over time. Although an oval shaped slot 112 is illustrated, the slot 112 may have various shapes, including but not limited to, rectangular, circular, or keyhole-shaped configurations, depending on design preferences and security requirements. The shape of the slot is configured to facilitate the insertion of a key while preventing unauthorized retrieval or tampering

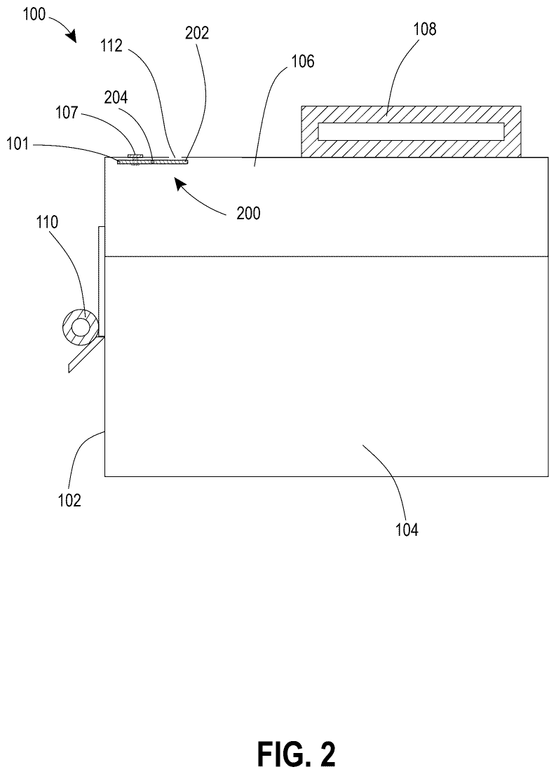

In one embodiment, the group lockout box 100 also comprises a mechanical seal 200 (best seen in FIG. 2) disposed within or adjacent to the slot 112. Advantageously, the mechanical seal 200 allows passage of the key 300 through the slot 112 into the interior of the box 100 without opening the cover 106 and seals the slot 112 upon passage of the key 300 through the slot 112 to prevent access into the interior of the body 104. Since the mechanical seal is biased in a closed positioned, the mechanical seal 200 automatically closes the slot 112 after each key entry, thereby preventing the key 300 from returning back through the slot 112 once the key 300 has passed through the slot 112. Such a one-way entry mechanism provides enhanced security by preventing unauthorized individuals from reaching through the slot 112 to retrieve keys, ensuring compliance with lockout/tagout safety protocols. The automatic closing of the slot 112 by the mechanical seal 200 also prevents the key 300 from accidentally slipping through the slot 112 if the group lockout box 100 is turned upside down, thereby preventing incidental access or accidental removal of the keys received within the group lockout box other than by authorized individuals possessing an ability to open the cover 106 of the group lockout box 100.

Effectively, the group lockout box 100 provides a robust and secure solution for safely managing keys during lockout/tagout procedures, ensuring that only authorized personnel can access the stored keys. For example, in an industrial manufacturing plant, the group lockout box 100 may be used to store machine control keys, allowing maintenance teams to deposit keys securely without risking unauthorized access. Similarly, in an electrical facility, the group lockout box 100 can be used to store keys to power units, ensuring that machinery remains locked out during maintenance and minimizing the risk of accidental reactivation.

FIG. 2 shows a right-hand side sectional view of the group lockout box 100 of FIG. 1, in accordance with an embodiment of the present disclosure. As shown, the group lockout box 100 comprises the mechanical seal 200. The mechanical seal 200 is implemented as a spring-loaded cover configured to prevent unauthorized retrieval of keys through the slot 112 once they have been deposited and to prevent one or more keys from passing back through the slot 112 once the keys have been deposited into the group lockout box 100. In some embodiments, the mechanical seal 200 comprises a cover plate 202 with dimensions larger than those of the slot 112, ensuring complete coverage and secure sealing of the slot. More specifically, the cover plate extends beyond the edges of the slot. The cover plate 202 is designed to prevent insertion of unauthorized tools or objects, such as wires, that could be used to retrieve keys, thus enhancing the security of the group lockout box 100. The automatic closing of the slot 112 by the mechanical seal 200 also prevents the key 300 from accidentally slipping through the slot 112 if the group lockout box 100 is turned upside down, thereby only allowing access to the deposited keys by opening the cover 106.

In some embodiments, the mechanical seal 200 also comprises a spring hinge 204 connected to the cover plate 202 and a mounting plate 101. The spring hinge 204 is configured to be biased in a closed position. In some embodiments, the mounting plate 101 is mounted to the cover 106 by pair of fasteners 107 (FIGS. 1-3). The fasteners 107 may be rivets, welds, screws, adhesives, or any other suitable fasteners. The biased spring hinge 204 ensures that the cover plate 202 automatically returns to a closed position over the slot 112 as soon as a key is passed through the slot 112. In some embodiments, the spring used in the spring hinge 204 can be fabricated from durable, high-tension materials such as stainless steel or alloyed spring steel, providing resilience and maintaining consistent force over repeated use. The use of the spring hinge 204 reduces costs associated with manufacturing the group lockout box 100 through implementation of the simple, easy to produce and commonly available mechanism such as the spring hinge 204 for ensuring that the cover plate 202 automatically returns to the closed position or default state upon passage of the key 300 through the slot 112.

Due to the dimensions of the cover plate 202, the spring-loaded design of the mechanical seal 200 provides a self-sealing slot, enhancing the tamper resistance of the group lockout box 100, wherein the cover plate 202 automatically closes the slot 112, preventing the insertion of unauthorized tools that could potentially retrieve keys from the interior, maintaining secure storage for the keys throughout the lockout period. Additionally, the self-sealing feature ensures ease of use, as authorized personnel do not need to manually seal the slot after each key entry, reducing time spent on repetitive actions and enhancing workflow efficiency during lockout/tagout procedures. The self-sealing nature of the slot 112 by the mechanical seal 200 also ensures that the keys once received within the interior do not pass back through the slot 112, thereby preventing loss or misplacement of the keys, thus enhancing security associated with storage of the keys within the group lockout box 100.

FIG. 3 shows a right-hand side sectional view of the group lockout box 100 of FIG. 2, in accordance with an embodiment of the present disclosure. As shown, a key 300 is inserted into the slot 112. The pushing of the key 300 against the cover plate 202 causes hinged opening of the cover plate 202 from the slot 112 to pivot downward to allow passage of the key 300 through the slot 112. Subsequently, when an entirety of the key 300 has passed through the slot 112, the spring hinge 204 causes the cover plate to pivot upward to engage the underside of the cover 106, thereby closing the cover plate 202 beneath the slot 112 to prevent unauthorized access to the key 300 stored within the body 104 and returning the group lockout box 100 to a default state thereof shown in FIG. 2.

In some embodiments, a bottom surface of the body 104 may comprise a magnetic surface to securely store the received key within the interior of the group lockout box 100. The magnetic surface holds the deposited keys in a fixed position, preventing them from shifting or becoming disorganized within the interior. Such a feature enhances the security of the group lockout box 100, as the magnetic attraction ensures that keys remain out of reach from the slot 112, even if attempts are made to retrieve them by tampering with the mechanical seal 200. The magnetic surface can be fabricated using neodymium magnets or other rare-earth magnetic materials, providing a strong and consistent magnetic hold that resists movement from vibrations or impact. Such an arrangement keeps the keys organized, preventing potential misplacement or damage, while adding an extra layer of tamper resistance to the lockout box.

In some embodiments, at least one of the body 104 and the cover 106 of the group lockout box 100 may comprise a see-through window. The see-through window allows authorized personnel to view the interior of the group lockout box 100 without needing to open the cover 106, enabling quick visual confirmation of the presence of deposited keys as well known in the art. Such a feature enhances operational efficiency, as users can verify the status of the lockout without compromising the security provided by the locked cover 106. In some embodiments, the see-through window can be fabricated from durable, transparent materials such as polycarbonate or tempered glass, which resist impacts and tampering. The material of the see-through window may also be treated with anti-scratch coatings, ensuring clear visibility over prolonged use. The placement of the see-through window can be customized, such as centrally on the cover 106 or along the body 104, allowing users to easily check the contents from various angles. In alternative embodiments, the see-through window may be provided by a transparent section, an aperture, or a cutout in the body 104 or cover 106.

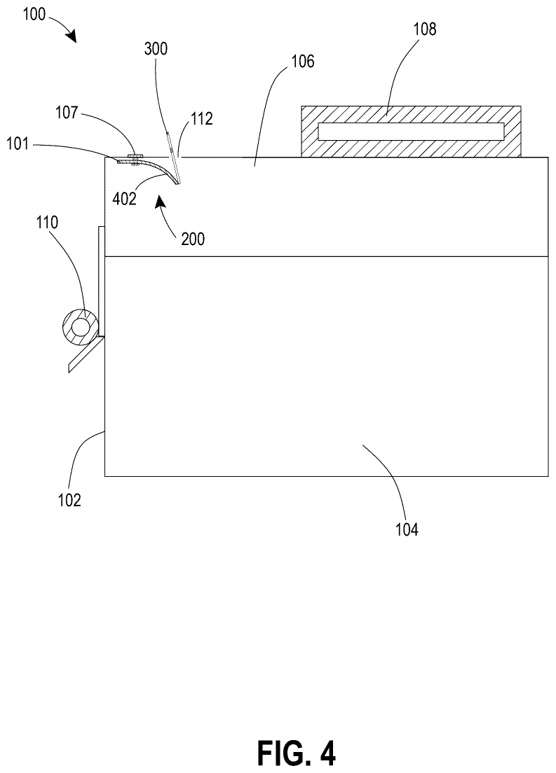

FIG. 4 shows a right-hand side sectional view of the group lockout box 100 of FIG. 1, in accordance with an alternative embodiment of the present disclosure. In this embodiment, the mechanical seal 200 is implemented as a diaphragm 402. The diaphragm 402 acts as a flexible barrier that permits one-way entry of keys 300 into the interior of the group lockout box 100, effectively sealing the slot 112 after each key 300 is deposited.

In some embodiments, the diaphragm 402 may be fabricated from resilient, puncture-resistant materials such as silicone or thermoplastic elastomer (TPE), which allow repeated deformation without compromising their sealing properties. The diaphragm 402 is dimensioned to securely receive standard key sizes while preventing unauthorized objects from being inserted through the slot 112.

Such a design provides enhanced security by minimizing the risk of tampering attempts to retrieve keys 300 from within the lockout box 100, while also offering a low-maintenance, self-sealing solution for secure key entry. In one embodiment, the diaphragm 402 is mounted by fasteners 107 to the cover 106 via its mounting plate 101.

During use, as the user pushes the key 300 against the diaphragm 402, the flexible diaphragm bends, allowing the key to pass through the slot 112 and enter the interior of the lockout box 100. Once the key has passed through, the flexible diaphragm returns to its original position against the slot, providing a barrier that prevents unauthorized access

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

The foregoing description and accompanying figures illustrate the principles, embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

What is claimed is:

1. A group lockout box for securely storing keys therein, the group lockout box comprising:
a housing defining an interior for receiving one or more keys, the housing comprising:
a body;
a cover coupled to the body so as to be movable between an open position and a closed position in which access to the interior is prevented;
a cover locking mechanism configured to secure the cover in the closed position;
a slot disposed in the cover, the slot being dimensioned to allow passage of at least one key into the interior without opening the cover; and
a mechanical seal disposed adjacent to the slot and configured to permit one-way insertion of the key into the interior and to prevent retrieval of the key through the slot after insertion.

2. The group lockout box of claim 1, wherein the mechanical seal comprises a spring-loaded cover including:
a cover plate sized larger than the slot; and
a spring hinge connected to the cover plate, wherein the spring hinge pivotally connects the cover plate to the mounting plate such that the cover plate automatically returns to cover the slot and prevents passage of the key back through the slot after insertion.

3. The group lockout box of claim 2, further comprising a mounting plate fixed to an underside of the cover, wherein the spring hinge pivotally connects the cover plate to the mounting plate so that the cover plate automatically returns to cover the slot upon passage of the key.

4. The group lockout box of claim 3, wherein the mounting plate is attached to the underside of the cover by one or more fasteners.

5. The group lockout box of claim 1, wherein the mechanical seal comprises a flexible diaphragm configured to allow the key to pass therethrough in a one-way manner.

6. The group lockout box of claim 1, wherein the cover locking mechanism is implemented as a latch clamp pivotally connected to the cover and configured to receive the padlock so as to secure the cover in the closed position.

7. The group lockout box of claim 1, further comprising a handle disposed on the cover for carrying the group lockout box.

8. The group lockout box of claim 1, wherein at least one of the body or the cover includes a window or an opening that allows visual inspection of the interior without opening the cover.

9. The group lockout box of claim 1, further comprising a magnetic surface disposed along a bottom interior region of the body, the magnetic surface being configured to retain the key in a fixed position within the interior once inserted.

10. The group lockout box of claim 1, wherein the slot has a shape selected from the group consisting of a rectangular slot, a keyhole slot, and an oval slot configured to limit insertion of unauthorized tools.

11. A mechanical seal for a lockout box slot, comprising:
a cover plate sized larger than the slot; and
a spring hinge biasing the cover plate to a closed position, wherein the mechanical seal permits one-way insertion of a key through the slot and prevents retrieval of the key after insertion.

12. A group lockout box for securely storing keys therein, the group lockout box comprising:
a housing defining an interior for receiving one or more keys, the housing comprising:
a body;
a cover coupled to the body so as to be movable between an open position and a closed position in which access to the interior is prevented;
a cover locking mechanism configured to secure the cover in the closed position;
a slot disposed in the cover, the slot being dimensioned to allow passage of at least one key into the interior without opening the cover; and
a spring-biased mechanical seal disposed within or adjacent to the slot and configured to permit one-way insertion of the key into the interior and to prevent retrieval of the key through the slot after insertion.
